(19) United States
(12) Patent Application Publication
(10) Pub. No.: US 2022/0122484 A1
(43) Pub. Date: Apr. 21, 2022

(54) Automatic Question Generation for Virtual Math Tutoring

(71) Applicant: WESLEY T. CHUANG, Vienna, VA (US)

(72) Inventor: WESLEY T. CHUANG, Vienna, VA (US)

(21) Appl. No.: 17/482,558

(22) Filed: Sep. 23, 2021

Related U.S. Application Data
(60) Provisional application No. 63/092,122, filed on Oct. 15, 2020.

(51) Int. Cl. G09B 19/02; G09B 7/04

(52) U.S. Cl. CPC G09B 19/025; G09B 7/04

(57) ABSTRACT

A method, system, and apparatus for providing individualized math instruction or tutoring that analyzes and adapts to student progress utilizes a unique method of automatically generating mathematical test questions, in which the mathematical test questions are generated by inserting randomly generated numbers into mathematical expressions whose operators follow basic mathematical properties to compose a true statement or equation, and then masking one or more of the numbers and asking students to complete the unknowns to satisfy the statement or equation. Student progress is then analyzed based on responses to the test questions, and modified test questions are generated or retrieved from a database in order to address weaknesses or strengths in specific categories.

This application claims the benefit of provisional U.S. Patent Appl. Ser. No. 63/092,122, filed Oct. 15, 2020, and incorporated herein by reference.

### BACKGROUND OF THE INVENTION

### 1. Field of the Invention

The invention relates to provide improvements in existing distance learning methods and systems, and in particular to improvements in distance learning technology related to teaching or tutoring of mathematics.

The invention also relates to improvements in existing math teaching or tutoring technology, and in particular to a method, system, and apparatus capable of generating test questions and modifying the test questions utilizing machine learning to create tests and teaching materials adapted to student progress and areas of strength and weakness for individual students or groups.

In one aspect of the invention, the machine learning may take into account feedback from students, teachers, and/or software engineers, in addition to test taker responses, for example by processing and applying the responses and feedback as machine learning labels for input to the machine learning network or system in order to iteratively improve the models and algorithms used to generate the expressions, equations, and objects that make up the test questions.

According to another aspect, the method, system, and apparatus of the invention may utilize a unique method of automatically generating mathematical test questions, in which the mathematical test questions are generated by inserting randomly generated numbers into mathematical expressions whose operators follow basic mathematical properties to compose a true statement or equation, and then masking one or more of the numbers and asking students to complete the unknowns to satisfy the statement or equation. The mathematical expressions may involve graphs and geometric figures as well as algebraic formulae.

### 2. Description of Related Art

In times of pandemic, such as the Covid-19 pandemic of 2020, distance or virtual learning via the Interet or a private network is essential to protect the health of students and teachers or tutors. However, even in non-pandemic times, it is apparent that distance learning has numerous advantages, including reduced infrastructure, transportation, and overhead costs. Pre-recorded lectures and interactive software can be utilized to simulate a live classroom experience and reach large numbers of physically distant, and/or to supplement the classroom experience. It is now common, by way of example, for homework to involve practice questions supplied by a web server, providing the student with instantaneous feedback in the form of test answer correction.

One disadvantage of distance learning is that it is difficult to provide individualized instruction, especially for large classes. Even in a conventional in-person classroom setting, it is difficult for a teacher to identify every individual student's strengths and weaknesses, and to tailor instruction accordingly. In a distance learning context, the problem is exacerbated. Conventional automated distance learning programs have not addressed this deficiency.

Another disadvantage of distance learning is that it is easy for students to share answers to test or homework questions, depriving the collaborating students of the opportunity to fully benefit from the practice tests or homework, and making it even more difficult to accurately assess student progress. This is a particular problem in the context of multiple choice tests, and math tests that have a single unique answer. It is not practical for a teacher or tutor to provide each student with a different set of questions, which is the only effective way to prevent such collaboration in a remote learning contest.

There is accordingly an increasing need for ways to improve conventional distance learning or software/web assisted tutoring technology by (1) providing an improved math question generating method, system, and apparatus capable of generating math questions that are adapted to an individual student's capabilities and progress, and that are suitable for use in remote learning or tutoring, and (2) monitoring student progress and adapting the math questions based on an individual's or group's measured progress.

One application of the method, system, and apparatus of the invention is to generate multiple choice questions of the type used in standardized tests such as the SAT or ACT, and to assess student performance for purposes of preparing students for the actual test.

### SUMMARY OF THE INVENTION

It is accordingly a first objective of the invention to provide a method, system, and apparatus for overcoming the disadvantages of conventional distance learning methods and systems, by automatically generating test questions adapted for individual students or groups.

It is a second objective of the invention to provide a method, system, and apparatus that improves upon existing distance math learning technology by automatically generating math questions that take into account individual student strengths, weaknesses, and progress in particular areas.

It is a third objective of the invention to provide a system and method of generating and verifying math questions based on analysis of test taker responses, and supplying questions of appropriate difficulty and topic.

It is a fourth objective of the invention to provide a system and method of generating and verifying math questions that not only takes into account test taker responses, but also input from, for example, students, teachers, software engineers in order to provide incrementally corrected ground truth to the system, in order to progressively generate questions that are indistinguishable from those made by humans.

These and other objectives of the invention are achieved, in accordance with the principles of a preferred embodiment of the invention, by a specially programmed computer hardware and/or a web application and server that uses fundamental mathematical axiom and properties (distributive, commutative, and associative) to automatically generate mathematical expressions, equations, and geometric objects with multiple choices for students to select from. The student responses can then be analyzed to provide inputs to the computer hardware and/or web application in order to automatically generate additional mathematical expressions, equation, and geometric objects.

In order to adapt equations to particular students or groups of students, the method, system, and apparatus of the preferred embodiment is able to generate multiple mathematically intelligible/legitimate equations that test the same concept. This is accomplished by manipulating the right-hand-side and left-hand-side of a true statement, enabling mathematical equations to be made into a test using different values while testing the same concept.

In general, one innovative aspect of the subject matter described in this specification can be embodied in a computer and/or web application wherein minimal mathematical objects or templates can first be manually entered, trained, and subsequently automatically generated, serving its educational purposes.

To facilitate the generation of test questions, a preferred question generating method is provided that includes the steps of randomly generating numbers, plugging these numbers into equations whose operators follow basic mathematical properties (such as distributive, commutative and associative), composing a true statement or equation, purposely masking one or many numbers, and then asking students to complete the unknowns from either the left-hand-side or the right-hand-side in order to satisfy the equation.

Generally speaking, the question generating methods of the illustrated embodiments generates the test questions by reversing (or backward chaining) the derivation steps or causal effect of logical reasoning, for posing questions from one step to the other, both of known truths. One of the methods includes randomly assigning mathematical objects into known mathematical formula, algebraic factorization, algebraic derivation, theorem derivation, or geometric transformation; constructing a true statement about the equation, mapping, or orientation, and then masking one or many objects or factors in the true statement and asking students to uncover the unknown.

The questions generated by the exemplary method may then be dynamically adapted to individual students or groups by using machine learning techniques based on the student responses to the questions. According to this aspect of the invention, the feedback or correctness off one test question type and its constituents become machine learning labels and are learned by machine learning algorithms to more accurately predict what type, what parameter values, to what degree of difficulty next question be generated, and to monitor students' progress of the topic in a pedagogical setting.

Because the “ground truth” of the exemplary embodiments of the invention, i.e., the answer keys with which students will be graded, is provided by the students themselves as part of an iterative process, an initial or small set of ground truth may be required to provide a basis for subsequent iterations. This chicken-or-egg causality dilemma similar to the one disclosed in copending U.S. patent application Ser. No. 17/221,994, entitled “Artificial Intelligence Annotation Through Gamification,” and is resolved by providing for the initial or small set of ground truth to be manually entered. The initial manual entry may be made by an initial population of selected students, or by other competent parties such as teachers and/or software engineers. In addition, it will be appreciated that any subsequently applied machine learning techniques may also take into account feedback from other experts or stakeholders, or the general public, including teachers and software engineers as well as students, in order to provide incrementally corrected ground truth to the system.

For example, this feedback can be accomplished by prompting “Is the question mathematically valid, or how would you make the questions legitimate?” The answers can be used to eliminate non-testable questions generated by initial machine learning models, in order to improve the models and progressively generate questions as if they were made by humans. According to yet another optional aspect of the invention, participation in the machine learning process may be encouraged by gamification of the tests, i.e., by presenting test questions as part of a game in which participants compete against other for high scores or even monetary rewards.

The proposed methods may then be used to provide a graphical user interface, wherein mathematical multiple-choice test questions are programmatically generated with random numbers or objects, constructed as mathematically truth statements, focusing on areas in which students deem less knowledgeable of; encoded internally as XML and HTML.

Mathematical descriptions and expressions can be learned by building a language model from world knowledge (e.g. Wikipedia and Web Texts) and from thousands of existing test questions. The former is similar in part to recent deep learning effort by OpenAI, where the GPT (Generative Pre-trained) model is able to generate fake news. The purpose here is not to generate regular natural language text, but to generate math test questions whose syntaxes are math worthy. The latter governs tuning of mathematical parameters.

The degree of difficulty comes from statistics of questions being correctly answered, grouped by the question categories. Machine learning occurs in two aspects: first in learning the language model for generating problem statements that make sense; second for learning to what degree of difficulty the next set of questions will be generated.

The system and apparatus of the invention preferably includes one or more databases in which initial test questions are deposited, and which include mathematical formula and theorems, etc., the databases being arranged to further store subsequently generated questions and their statistics so that not only student learning, but question generation are both in a forever learning loop adapted to dynamically address the needs of students and groups in order to provide a learning environment that dynamically tracks and adjusts to the strengths and weakness of individual students and groups, transforming the disadvantages of conventional distance or remote instruction software into an asset that enhances math instruction and tutoring.

The principles of the preferred embodiments of the invention are not limited to simple equations, but may also be applied to math questions involving graphs, more advanced algebraic or polynomial equations, and geometric objects.

### BRIEF DESCRIPTION OF THE DRAWINGS

FIG. 1 is a block diagram of a system for generating mathematical test questions according to the principles of a preferred embodiment of the invention.

FIG. 2 is schematic diagram of a process for inserting values into a template according to the principles of the preferred embodiment.

FIG. 3 shows an example of a multiple choice test question generated by the system and method of the preferred embodiment.

FIG. 4 illustrates a possible internal representation of the exemplary test question illustrated in FIG. 3.

FIG. 5 shows another example of a multiple choice test question generated by the system and method of the preferred embodiment.

FIG. 6 is a schematic diagram of an internal table for graph illustrated in FIG. 5.

FIG. 7 shows another example of a multiple choice test question generated by the system and method of the preferred embodiment.

FIG. 8 is a schematic diagram of a process for inserting values into a template to obtain the test question of FIG. 7.

FIG. 9 illustrates a process of backward chaining to generate polynomial factor derivations for use in the method and system of the preferred embodiment.

FIG. 10 shows a further example of a multiple choice test questions generated by the system and method of the preferred embodiment.

### DETAILED DESCRIPTION OF THE PREFERRED EMBODIMENTS

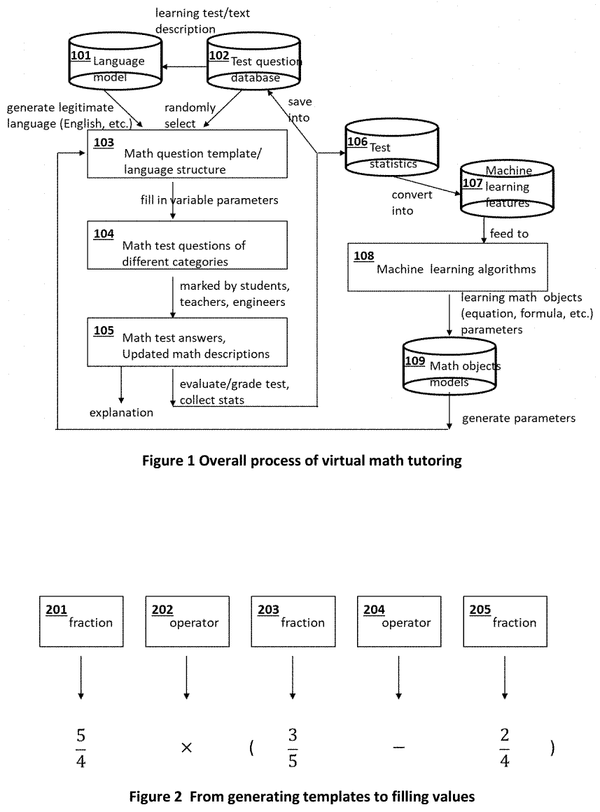

As shown in FIG. 1, an exemplary system constructed in accordance with the principles of a preferred embodiment of the invention includes a processor or processors 103-105 for implementing the following processes: (a) generating templates or structured objects into which specific parameter values are inserted, based on test parameters or previous test results stored in a database 102, with the optional assistance of a language model 101 (step 103); (b) compiling individual test questions from different categories into a test to be taken by students (step 104); and evaluating or grading student answers in order to measure student progress. The tests and evaluation results are stored in the database 102 and used to generate additional test questions.

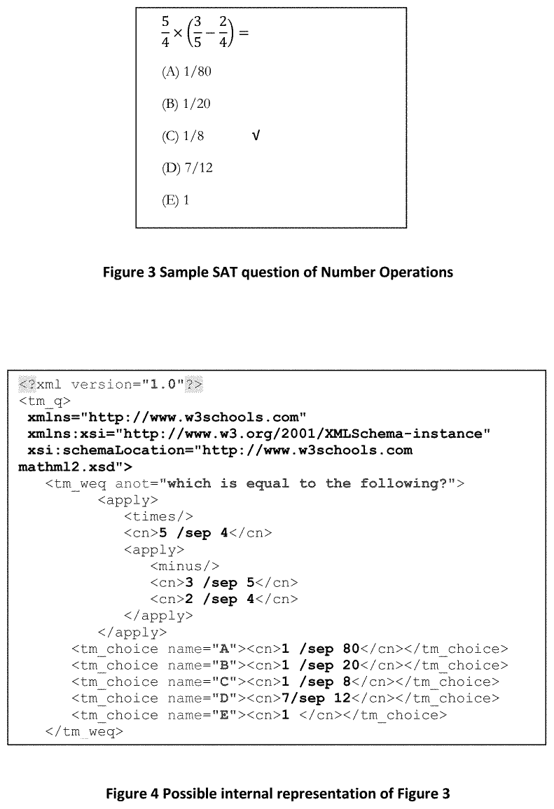

Question generating step 103 is further illustrated in FIGS. 2 and 3, which respectively illustrate a template and a test question generated using the template. The template consists of a syntactically correct sequence of mathematical objects that represent a fundamental mathematical axiom or property. Examples of properties include the distributive, commutative, and associative properties, which for example allows the expression shown in FIG. 2,

7/5×(3/7−2/5)

to be rewritten as

(7/5×3/7)−(7/5×2/5)

or

(3/7×7/5)−(7/5×2/5),

and so forth. In the illustrated example, the template consists of fraction blocks 201, 203, and 205, and operators 202 and 204. It will be appreciated that the fraction blocks can be replaced by any type of variable or number, and that the operators may include any mathematical operator appropriate for the intended student level.

After inserting values into the template, different equations can be generated by using these properties to manipulate left and right sides of the equality. This allows the mathematical equations to be assembled into a test directed to a specific mathematical concept.

In order to serve as test questions, it is not enough for equations to be constructed solely from templates and randomly generated numbers. Many algebraic equations are subject to constraints. For example, a fraction cannot have zero in the denominator. These and other constraints are applied in a template constructing sub-system that utilizes test statistics to determine equation difficulty or areas that require emphasis for particular students or groups of students. The statistics are processed in a module 106 and input to template generating module 107. Test generating module 108 may use machine learning or artificial intelligence to compare expected and actual test results in order to refine previous template generating algorithms and apply mathematical constraints. The templates are then utilized to form equations that are assembled into tests in accordance with steps 103.

Whether or not to add the parentheses to indicate precedence of operators will also be learned in 108. This is the simplest type of automation for generating math test questions.

In order to begin the iterative process, an initial or small set of ground truth may be manually input to provide a basis for subsequent iterations. The initial manual entry may be made by an initial population of selected students, or by other competent parties such as teachers and/or software engineers. By way of explanation, the initial entry and subsequent iterations may be thought of as analogous to a democratic voting system that aggregates trusted participants' opinions to an “asymptotic” truth (i.e., the “right” answer). The use of “trusted” participants ensures that the future model (109) will favor those that answer more correctly (106).

FIGS. 3-7 illustrated, by way of example and not limitation, different types of math questions to which the method, system, and apparatus of the invention may be applied. Though math question types are not exclusively listed here, one innovative aspect of the preferred method, system, and apparatus is that all of these test questions can be automatically generated by following certain principles. In general, different types of questions exhibit specific rhetorical structures, whose templates can be learned and generated by the language model 101. To build such a language model, training texts may come from the text portion of the test question database 102 and other pre-trained language models such as OpenAI GPT (Generative pre-training). From a pre-trained model like GPT, it learns general world knowledge, whereas the existing test questions offer syntaxes and types related to specific math categories—graphs, algebra, and geometry and so on. Auto-generated templates and associated text description are represented in 103 of FIG. 1. Auto-generated final questions are represented in 104 of FIG. 1.

FIG. 4 displays one possible internal representation for the test question from FIG. 3. It is an XML (Extensible Markup Language). The semantically enriched tag format allows test questions to be easily traversed, searched, partitioned, and serialized. Subsequently, it can be easily rendered in a browser for students taking the test. Another important benefit for using the XML is for any constituents/attributes to be randomly replaced or assigned with other values, essentially expanding the size of the test dataset to near infinity. Encoding test questions in XML not only applies to Numbers Operations (FIG. 3), but to test questions of other types.

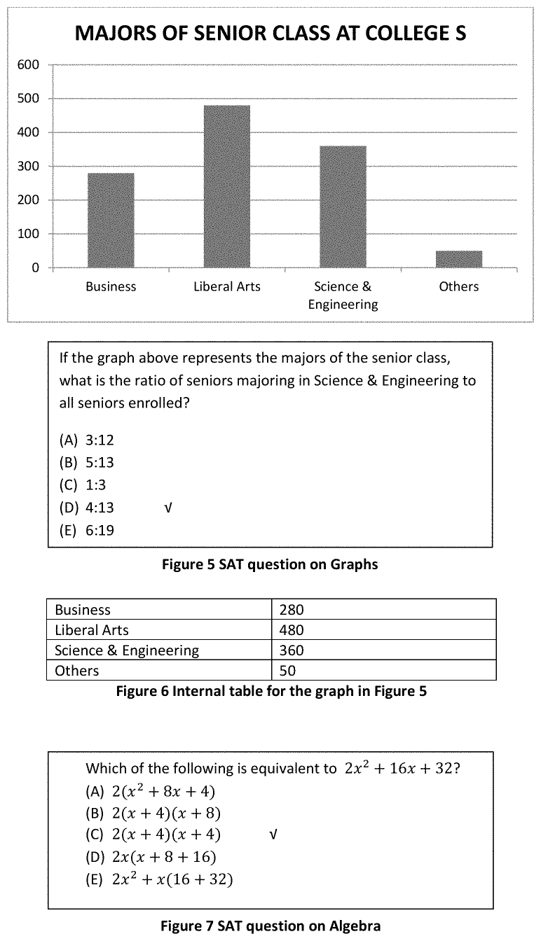

As illustrated in FIG. 5, the math questions that may be generated include graphs as well as pure equations. In this example, the questions come from a template with a graph of column chart and its text description, and multiple choices. Internally, the graph portion may be as simple as the table shown in FIG. 6, which can also be automatically generated. The template could have been a line, column, pie, or bar chart. Regardless, the graph can be implemented by computer code, e.g. JavaScript, and be rendered in a browser.

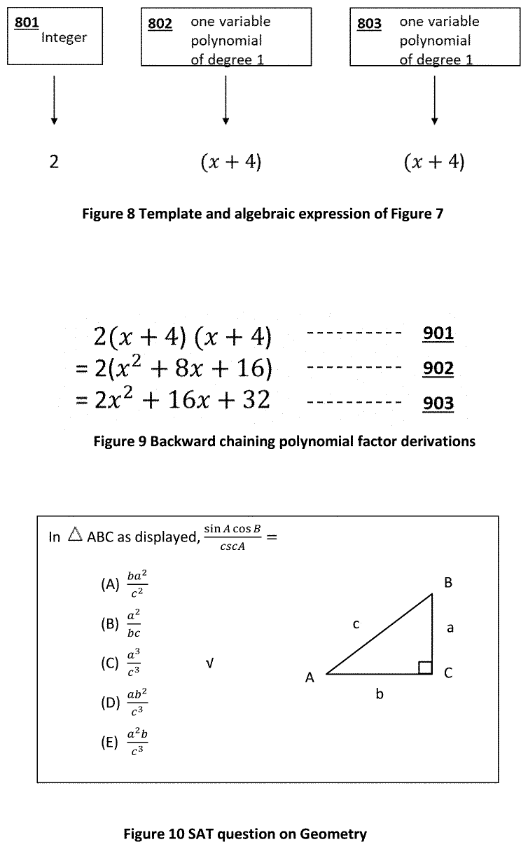

FIG. 7 illustrates another question type, in the form of algebraic equations. The example shown in FIG. 7 is a one-variable quadratic polynomial and its factorized form. The template, in this case, can come from one of its multiple choices—the answer in a factorized form. Shown on the top in FIG. 8 is the corresponding template, comprised of one integer and two one-variable polynomial of degree 1 (801-803). The template leads to a factorized polynomial (901), before being derived to come up with the polynomial (903) in the question, shown in FIG. 9. While the student is tested on factorizing a polynomial, the question can be generated by backward chaining; that is, inferenced from the opposite direction.

The method, system, and apparatus of the invention can also generate questions of this type from the quadratic polynomial. For example, one can take advantage of the quadratic root formula and derive the factorized form from a quadratic polynomial. However, in most cases, it is easier to make a question by starting with the factorized form. Either way, every step of the derivation of the expression becomes a potential question, and can be made with certain parameter values masked, because 901-903 are equivalent expressions.

FIG. 9 illustrates yet another question type, involving geometry. Its math expression involves a fraction with numerator and denominator being composed of Trigonometric functions. All the variables to the fraction, including constituents to the triangle can all be randomly generated, while obeying its mathematical properties, with the possibility of being constrained to special angles so that the questions will not be strangely difficult. The answer to the question can be derived by computer once the question is generated. Similar to the graph question, a triangle can be implemented by computer code, e.g. JavaScript, and be rendered in a browser.

An especially advantageous aspect of the method, system, and apparatus of the illustrative embodiments is that automatically generated math questions serve to facilitate virtual learning. It is important that a student progress be accurately supervised. It is feasible, because each student's answer to a question will be automatically graded (105), with explanation being offered by revealing (sometimes reversing) the derivation of the math equation leading to the answer. Furthermore, after a students' answer is evaluated against the ground truth, statistics can be obtained showing the degree of difficulty of each question among the categories, or the performance of a student's standing among the population. This provides a basis (106) for helping a student to practice further tests in a certain category with a certain degree of difficulty.

The test questions being generated together with the initial set can all be converted into machine learning features (107) from text descriptions and their underlying math expressions, formula, and equations, etc. Multiple machine learning algorithms (108) can take these features and learn to produce a better model (109) iteratively. There are several models in discussion. One is the pre-trained language model (i.e. 101 before fine-tuning) available from the open source domain, for providing baseline natural language expressions. The second is the language model (101) being fine-tuned, responsible for generating better question templates using correct math language. The third model (109) is trained from features of math equations, formula, etc., for correctly inserting parameter values to the math expressions.

Optionally, machine learning can take into account not only analysis of student responses, but also direct feedback from students, teachers, software engineers, and other qualified to comment on the legitimacy of the test questions. The feedback can be in response to prompts directed to paid consultants or volunteers, or even to members of the general public recruited through gamification of the tests.

In summary, the present invention improves upon existing remote learning technology and software by providing a way to generate mathematical test questions to which machine learning techniques may be applied in order to adapt the questions based on analysis of student responses to the questions, and thereby provide individualized instruction or tutoring in a remote learning environment. To accomplish this, exemplary embodiments of the invention utilize a unique method of automatically generating mathematical test questions, including questions related to algebra, geometry, or graphs, in which the mathematical test questions are generated by inserting randomly generated numbers into mathematical expressions whose operators follow basic mathematical properties to compose a true statement or equation, and then masking one or more of the numbers and asking students to complete the unknowns to satisfy the statement or equation.

What is claimed is:

1. A remote mathematics teaching or tutoring method, comprising the steps of:
automatically generating test questions and supplying them via a graphical user interface to at least one test taker;
verifying test taker responses to multiple said test questions;
statistically analyzing the responses; and
generating additional templates taking into account results of the response verification and the statistical analysis.

2. A method as claimed in claim 1, wherein the additional templates are generated with assistance of machine learning.

3. A method as claimed in claim 2, wherein the additional templates are assigned a category and precise level of difficulty for presentation to a test taker or group of test takers based on analysis of previous test responses indicative of student or group progress with respect to a respective category.

4. A method as claimed in claim 2, wherein the machine learning takes into account analysis of test taker responses and direct human feedback concerning the legitimacy of automatically generated test questions, in order to iteratively improve models used to generate the additional templates.

5. A method as claimed in claim 1, wherein the test questions are generated by:
assembling a template including a plurality of first objects representing functions or numerical variables and, second objects representing operators;
inserting numerical values into the first objects to form an equality or true statement;
verifying that the equation is mathematically valid;
if the equation is mathematically valid, marking the equation as valid;
masking one of the objects,
storing the test question in a database for subsequent presentation to a test taker,
wherein, upon presentation to the test taker, prompting a test taker to fill in the object to recreate the equality or true statement.

6. A method as claimed in claim 5, wherein the numerical values are randomly generated.

7. A method as claimed in claim 5, further comprising the step of, upon receiving an incorrect test answer from a test taker, providing an explanation of the correct answer and mathematical principles to the test taker.

8. A method as claimed in claim 1, wherein the test questions include questions involving algebra, geometry, and/or graphs.

9. A method of automatically generating mathematical test questions, comprising the steps of:
assembling a template including a plurality of first objects representing functions or numerical variables and, second objects representing operators;
inserting numerical values into the first objects to form an equality or true statement;
verifying that the equation is mathematically valid;
if the equation is mathematically valid, marking the equation as valid;
masking one of the objects,
storing the test question in a database for subsequent presentation to a test taker,
wherein, upon presentation to the test taker, prompting a test taker to fill in the object to recreate the equality or true statement.

10. A method as claimed in claim 9, wherein the numerical values are randomly generated.

11. A method as claimed in claim 9, wherein the test questions include questions involving algebra, geometry, and/or graphs.

12. A remote mathematics teaching or tutoring system, comprising:
at least one database; and
programmed processing hardware including stored machine executable instructions for:
automatically generating test questions and supplying them via a graphical user interface to at least one test taker;
verifying test taker responses to multiple said test questions;
statistically analyzing the responses;
generating additional templates taking into account results of the response verification and the statistical analysis; and
storing generated test questions, responses, and statistics in the database.

13. A system as claimed in claim 12, wherein the additional templates are generated with assistance of machine learning.

14. A system as claimed in claim 13, wherein the machine learning takes into account analysis of test taker responses and direct human feedback concerning the legitimacy of automatically generated test questions, in order to iteratively improve models used to generate the additional templates.

15. A system as claimed in claim 13, wherein the additional templates are assigned a category and precise level of difficulty for presentation to a test taker or group of test takers based on analysis of previous test responses indicative of student or group progress with respect to a respective category.

16. A system as claimed in claim 12, wherein the test questions are generated by:
assembling a template including a plurality of first objects representing functions or numerical variables and, second objects representing operators;
inserting numerical values into the first objects to form an equality or true statement;
verifying that the equation is mathematically valid;
if the equation is mathematically valid, marking the equation as valid;
masking one of the objects,
storing the test question in the database for subsequent presentation to a test taker,
wherein, upon presentation to the test taker, prompting a test taker to fill in the object to recreate the equality or true statement.

17. A system as claimed in claim 16, wherein the numerical values are randomly generated.

18. A system as claimed in claim 16, further comprising machine executable instructions for, upon receiving an incorrect test answer from a test taker, providing an explanation of the correct answer and mathematical principles to the test taker.

19. A system as claimed in claim 12, wherein the test questions include questions involving algebra, geometry, and/or graphs.

20. Apparatus for implementing the method of claim 1.
